(19) United States
(12) Patent Application Publication
(10) Pub. No.: US 2010/0176209 A1
(43) Pub. Date: Jul. 15, 2010

(54) Engine block warming controller

(76) Inventor: John W. Van Cleve, Sykesville, MD (US)

Correspondence Address: LITMAN LAW OFFICES, LTD., POST OFFICE BOX 41200, SOUTH STATION, ARLINGTON, VA, 22204, US

(21) Appl. No.: 12/318,909

(22) Filed: Jan. 12, 2009

(51) Int. Cl. B60H 1/00

(52) U.S. Cl. 237/2 A; 219/205

(57) ABSTRACT

The engine block warming controller is an engine warming device for diesel engines. The controller includes a thermostat/temperature controller unit that monitors temperature outside during operation of the engine block warming controller. The unit includes a sensing probe for sensing the outside temperature. A heavy-duty outdoor timer controls time to turn on and off the engine block warming controller and a heavy-duty extension cord electrically connects the engine block warming controller to an engine cord of the vehicle. A backing board is used for securely receiving the engine block warming controller to mount it on an inside wall away from outside elements. A plurality of fasteners mounts the probe on an outside wall to detect a temperature of the outside elements. When the timer turns on the controller, the probe detects the outside temperature and warms the diesel engine.

### BACKGROUND OF THE INVENTION

1. Field of the Invention

The present invention relates generally to preheating and warming devices to be used with a motor vehicle in cold climates. More specifically, the present invention relates to an engine block warming controller for warming a vehicle engine, especially a diesel engine, in cold weather.

2. Description of the Related Art

Diesel engines are increasingly being used in automobiles, trucks and heavy equipment because they are more rugged and efficient than their gasoline counterparts and have longer life expectancies. The diesel engine does, however, experience some problems. One of these problems is the difficulty of starting a diesel engine in cold weather.

In the diesel engine, combustion takes place when air, compressed in the engine cylinders, reaches the ignition temperature of the diesel fuel. In warm weather, the intake air can easily reach the fuel ignition temperature when it is compressed. However, when a cold engine is started, some of the heat generated by the compression of the air in the cylinders is dissipated to the engine parts and results in the air not reaching the ignition temperature upon compression. Thus, at colder temperatures, especially below freezing, it can be difficult to start the diesel engine.

It has long been realized that the efficiency of vehicle engines decreases rapidly with the onset of colder temperatures. This is particularly true with diesel motor vehicles. As temperatures decrease, lubricants tend to increase in viscosity, thereby requiring greater energy on the part of the vehicle starting system to “turn over” a cold engine. At the same time, it is more difficult for fuel to vaporize, thereby also hindering the starting process. Yet, under the very conditions requiring maximum output from the vehicle electrical system, the typical vehicle battery has also lost efficiency due to the temperature decrease.

Even assuming that all the systems of the vehicle are in optimum operating condition, there will still be a great deal of increased wear and tear on the engine subjected to startup in such cold conditions. Due to the thickening of lubricants, more time is needed for the oil pump to force such lubricants to critical areas, and at the same time the excess fuel required tends to wash down or dilute what lubricants may remain in such critical areas from the previous time the vehicle was run. Typically, the vehicle battery is more deeply discharged during cold weather starting, which tends to shorten the life of the battery even if the vehicle charging system is operating optimally.

Although some motor vehicle preheating devices are known, they generally fall short of providing for all of the warming needs of modern diesel vehicle engines. The preheating of the diesel engine is helpful from the standpoint of driver comfort and safety, because the driver can attend to driving the vehicle more efficiently when not distracted by the discomfort of cold conditions as the engine warms to normal operating temperatures. However, in order to make use of these types of, devices to preheat the vehicles it is necessary to activate the devices some two hours or more prior to starting the vehicle due to the relatively low power output of the devices and the resulting time required to warm the related engine components thoroughly. For the diesel engine motorist, this requires either activating the devices before retiring for the night, which results in the usage of electrically energy for the entire night, or rising earlier in order to activate the devices to allow the thorough warming of engine components before starting the vehicle.

Presently, many of these devices have solid-state components. In cold climates, this becomes a problem because these solid-state components are very easily damaged from the cold weather. Additionally, these devices that use timers, do not use temperature sensitive timers. This is another problem, because each time the engine vehicle needs to be warmed, the timer has to be set. A still further problem arises when the temperature reaches a range that warming or preheating is not necessary. The timer related devices still heat the diesel engine, because the preset timer turns the device on to warm the already warm engine.

Thus, an engine block warming controller solving the aforementioned problems is desired.

### SUMMARY OF THE INVENTION

The engine block warming controller has a thermostat/temperature controller unit for monitoring outside temperature during operation of the engine block warming controller. The thermostat/temperature controller includes a sensing probe for sensing the outside temperature. The sensing probe is unaffected by barometric pressures and cross-ambient temperature. A capillary connects the sensing probe to the thermostat/temperature controller unit. The unit has an outlet box electrically connected to the thermostat/temperature controller. The outlet box includes an electrical cord electrically connected at one end to the outlet box and a plug end for receiving power. The controller further includes heavy-duty outdoor timer has two on/off settings per day for time controlling the engine block warming controller. The timer includes a heavy-duty twelve-inch grounded cord for receiving power and a receptacle for receiving the plug end of the electrical cord from the outlet box.

A heavy-duty extension cord electrically connects the outlet box of the engine block warming controller to an engine cord of a diesel vehicle.

A backing board having a finished plate of three-quarters of an inch white, vinyl material securely receives the thermostat/temperature controller unit, the electrically connected outlet box, and the heavy-duty outdoor time of the engine block warming controller. The backing board mounts the engine block warming controller on an inside wall away from outside elements.

A plurality of fasteners mount the probe on an outside wall to detect the temperature of the outside elements.

These and other features of the present invention will become readily apparent upon further review of the following specification and drawings.

### BRIEF DESCRIPTION OF THE DRAWINGS

FIG. 1 is an environmental, perspective view of an engine block warming controller according to the present invention.

FIG. 2 is an enlarged perspective view of the engine block warming controller of FIG. 1.

FIG. 3 is an exploded view of the engine block warming controller shown in FIGS. 1 and 2.

Similar reference characters denote corresponding features consistently throughout the attached drawings.

### DETAILED DESCRIPTION OF THE PREFERRED EMBODIMENTS

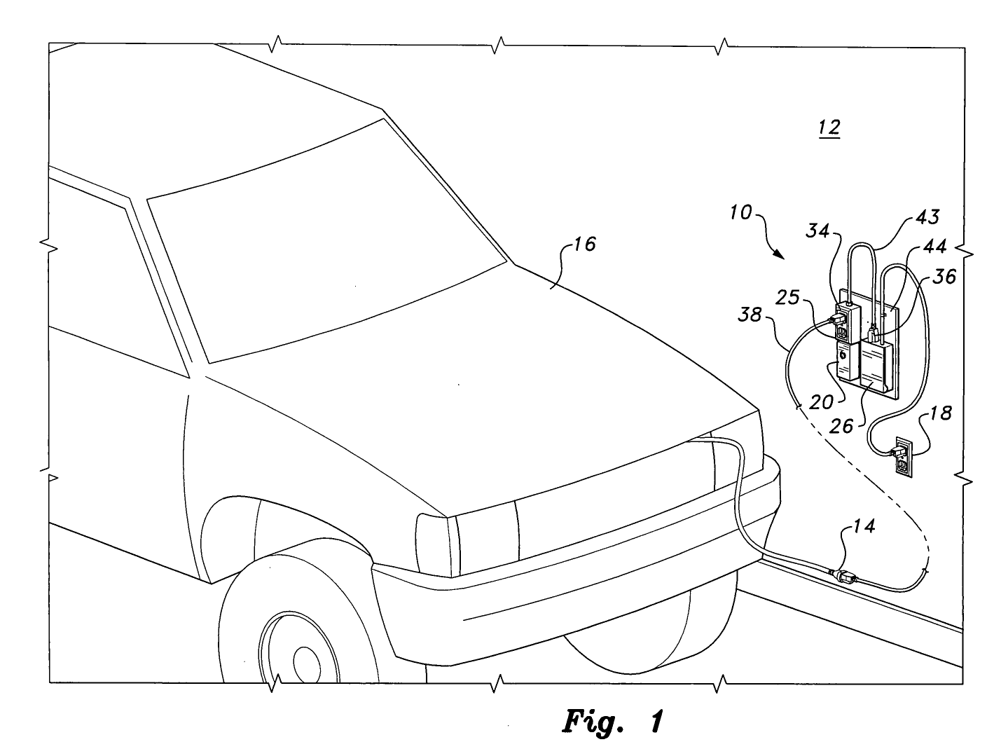

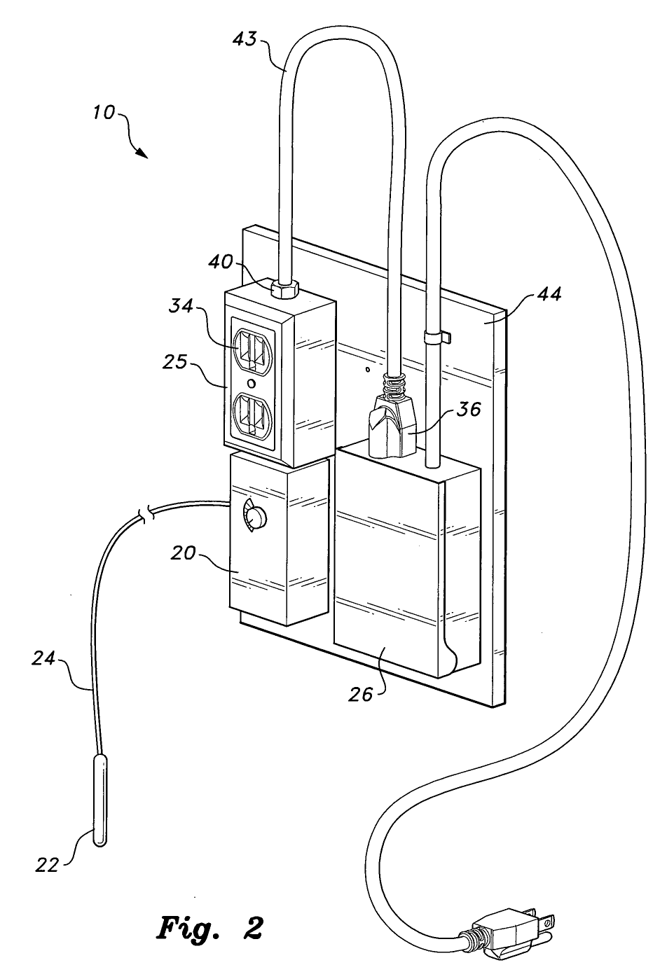

As shown in FIGS. 1-3, the engine block warming controller 10 is mounted inside a building, such as a garage 12. This keeps the controller 10 out of harsh weather. By mounting the controller 10 out of the harsh weather, the controller 10 can be electrically connected to a plug 14 from a diesel motor vehicle 16. Additionally, since the controller 10 is mounted indoors, out of the weather, it is also out of harm's way from being dropped or crushed in a driveway.

The engine block warming controller 10 includes a couple of components. There is a thermostat/temperature controller unit 20 that is a non-solid state component. As used herein, the term “electromechanical thermostatic switch” means a thermostatic switch using a mechanical spring or other non-solid state components for changing state at a set temperature. An exemplary thermostat/temperature controller unit 20 suitable for use in the engine block warming controller 10 is model #A19ABC-24C, made by Johnson Controls, Inc. of Milwaukee, Wis., which is a single-pole, double-throw remote bulb control for temperature controls that incorporate a liquid filled sensing element. The unit 20 is designed to cover a broad range of general purpose operating temperature control applications in the refrigeration, air conditioning, and heating fields. In fact, various control ranges are available to cover working temperatures from −30° to 225° Fahrenheit, (−35° to 105° Celsius).

The unit 20 is a compact, general purpose, temperature controller. The unit 20 is dependable and has precision snap-acting contacts in a dust-tight enclosure and a liquid filled sensing element 22. The sensing element or probe 22 has precision repeat accuracy that is unaffected by barometric pressure and cross-ambient temperature problems. The sensing probe 22 is connected to the unit 20 by way of a six-foot capillary 24. The thermostat/temperature controller unit 20 is electrically connected to an outlet box 25 that is totally controlled by the thermostat/temperature controller unit 20. The electrical connection to the outlet box 25 permits easy monitoring or control over the unit 20.

Another component of the engine block warming control 10 is a timer 26. An exemplary timer 26 suitable for use in the engine block warming controller 10 is made by Intermatic, Inc. of Spring Grove, Ill., and has model number HB31R. This is a heavy-duty outdoor timer that has two on/off settings per day, a waterproof cover, and is also non-solid state. The timer 26 can control heavy-duty loads (15 Amps) and has a heavy-duty twelve-inch grounded cord 28 and a receptacle 30. The HB31R has a temperature operating range of −40° C. to +40° C.

Those are the two main components. The other components or parts are off-the-shelf electrical parts from any major or local home remodeling or hardware stores. These parts are an electric plug 32, a grounded socket 34 in the outlet box 25, and a grounded plug 36 that are made by the Leviton Company. An extension cord 38 is used to electrically connect the engine block warming control 10 to the engine plug 14 of the diesel vehicle 16. The extension cord 38 is an off-the-shelf twelve-gage, three strand, heavy-duty extension cord. Additionally, off-the-shelf Romex® connector 40, used to secure a plug cord 43 at one end to the electrical outlet box 25. Romex® is a registered trademark of the Southwire Company at One Southwire Drive, Carrollton, Ga., 30119. The engine block warming controller 10 is mounted on a backing board 44. The backing board 44 is a finished plate of three-quarters of an inch thick. It is white and made of a vinyl material. The backing board 44 is cut to a size of twelve inches by nine inches.

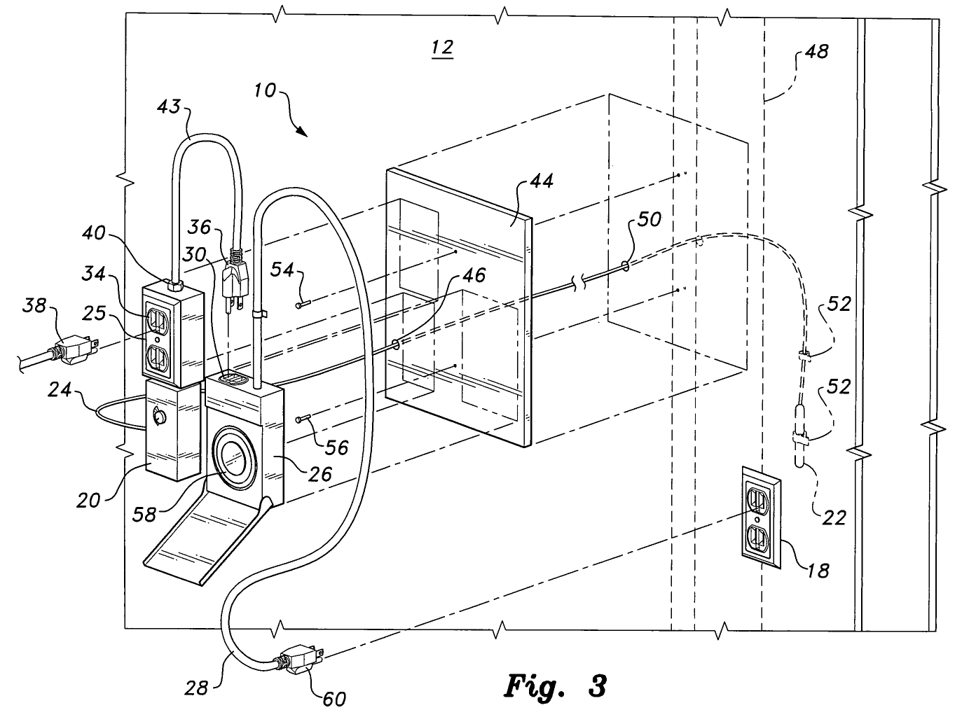

With reference to FIG. 3, the installation and operation of the engine block warming controller 10 is explained. The 110-volt outlet 18 is preferably located near a garage door or accessible door or window, (not shown). A one-inch temperature tube hole 46 that has been drilled in the backing board or plate 44 is located. The backing board 44 is placed in position on a stud 48 and with a pencil the tube hole 46 is used to mark another hole 50 on the wall. The wall hole 50 is drilled through the wall forming at least a half-inch in diameter hole to the outside so the probe 22 can be mounted in the outside air with clips, fasteners, or other fastening-type members 52. This should be done in a place where the outside air temperature is constant. For example, away from fans from heat pumps or other outside type of exhaust fans. Of course, there should be caution of pipes and wires in the wall so as not to drill into them. The probe 22 is secured with the fasteners 52, so as not to let it flap in the wind.

There are a number of protective screws 54, 56 that need to be removed from the mounting board 44 and saved for securing the mounting board 44 into the stud 48, prior to placing the probe 22 outside. The number of protective screws 54, 56 can be as many as four, but this depends on the mounting area and the number of protective screws needed to mount the board 44. In this embodiment, two protective screws 54, 56 are shown to simplify the description of the mounting of the board 44.

About twelve inches of the temperature probe capillary 24 is gently unwound. The capillary 24 must be held straight away from the rear of the board 44 in order that no kinks are made in the capillary 24. The probe 22 is then gently slid through the hole 46 and then through the wall hole 50 that was drilled to the outside. With the protective screws 54, 56 that were saved, the board 44 is mounted to the wall stud 48 about two inches above the 110-volt outlet 18. The temperature probe 22 is then secured to the outside of the building close to the wall with the fasteners 52. At this point, the temperature controller unit 20 can be set to about thirty degrees. Next, the timer 26 is set to the desired on and off time using dial 58 for a circuit operation and a correct time of day. The timer cord 28 with plug 60 is electrically connected to the 110-volt outlet 18. Finally, the extension cord 38 is electrically connected to the grounded socket 34 of the electrical box 25 and to the block heater plug 14 from diesel vehicle 16.

The engine block warming controller 10 does the work of warming the engine of the diesel vehicle 16. The controller 10 saves energy and worry. Through the thermostat/temperature controller unit 20, the outside temperature is monitored so that if the temperature outside does not fall below a set temperature, such as 30° Fahrenheit, then the engine is not heated and energy is not used to heat the diesel vehicle 16. If either system is to be used independently, just do so, or use them together, with the timer 26 being the first in the line, then the thermostat/temperature controller unit 20. The engine block warming controller 10 is readily adjustable by simply electrically connecting the components with the movement of the electric cord plugs.

It is suggested that extension cord 38 be a twelve-gage grounded extension cord that runs from the control panel to the vehicle. The extension cord 38 going to the vehicle 16 will be plugged either into the timer 26 or the socket 34 of the electrical outlet 25, depending on the desired usage of the engine block warming control 10, because the outlet 25 is totally controlled by the thermostat/temperature controller unit 20. The plug cord 43 is to the thermostat/temperature controller unit 20, and if the timer 26 is being used, the plug cord 43 is electrically connected to the timer 26. If only the thermostat/temperature controller unit 20 is to be used and the timer 22 is to be bypassed, then cord plug 43 from the thermostat/temperature controller unit 20 is electrically connected directly into the 110-volt outlet 18. Of course, it should be recognized that this is a fifteen-ampere circuit and only one outside vehicle should be plugged in at a time. In other words, do not gang plug vehicles. It should be noted that the engine block warming controller 10 also can be used for diesel engines, gas engines, or farm equipment or an engine that could use a warm engine for start-up.

It is to be understood that the present invention is not limited to the embodiment described above, but encompasses any and all embodiments within the scope of the following claims.

I claim:

1. An engine block warming controller, comprising:
a temperature-sensing probe adapted for sensing ambient temperature;
an electromechanical thermostatic switch connected to the temperature-sensing probe;
an electrical outlet box electrically connected to the thermostat/temperature controller, the thermostatic switch being connected to apply power to the outlet box when the ambient temperature falls below a set temperature;
an electrical plug connected to the thermostatic switch, the plug being adapted for connection to an electrical outlet; and
a heavy-duty outdoor timer having two on/off settings per day for time controlling the engine block warming controller, the timer including a heavy-duty twelve-inch grounded cord adapted for connection to an electrical outlet and a receptacle for receiving an electrical plug from a load;
wherein:
an engine block heater plug may optionally be connected to the outlet box, the thermostatic switch being connected directly to the a.c. power mains, for heating the engine block only when the ambient temperature falls below the set temperature; or
the engine block heater plug may optionally be connected to the timer receptacle, the timer being connected directly to the a.c. power mains, for heating the engine block only when during preset time intervals; or
an engine block heater plug may optionally be connected to the outlet box, the thermostatic switch being connected to the timer and the timer being connected to the a.c. power mains, for heating the engine block only when the ambient temperature falls below the set temperature during preset time intervals.

2. The engine block warming controller according to claim 1, further comprising a backing board, the backing board being a finished plate of three-quarters of an inch thick vinyl, the backing board securely receiving the thermostat/temperature controller unit, the electrically connected outlet box, and the heavy-duty outdoor timer, the backing board being adapted for mounting on an inside wall away from outside elements.

3. The engine block warming controller according to claim 1, further comprising a plurality of fasteners adapted for mounting the probe on an outside wall to detect the ambient temperature.

4. The engine block warming controller according to claim 1, wherein said temperature sensing probe comprises a liquid filled probe.

5. The engine block warming controller according to claim 4, further comprising a capillary connecting said temperature sensing probe to said thermostatic switch.

6. The engine block warming controller according to claim 1, further comprising a heavy-duty extension cord connected to the outlet box, the extension cord being adapted for connection to the engine block heater.
